(19) United States
(12) Patent Application Publication
(10) Pub. No.: US 2024/0069347 A1
(43) Pub. Date: Feb. 29, 2024

(54) SYSTEM AND METHOD USING EYE TRACKING ILLUMINATION

(71) Applicant: Meta Platforms Technologies, LLC., Menlo Park, CA (US)

(72) Inventors: Wei RONG, San Jose, CA (US); Sascha HALLSTEIN, Saratoga, CA (US)

(73) Assignee: Meta Platforms Technologies, LLC., Menlo Park, CA (US)

(21) Appl. No.: 18/113,932

(22) Filed: Feb. 24, 2023

Related U.S. Application Data
(60) Provisional application No. 63/401,317, filed on Aug. 26, 2022.

(51) Int. Cl. G02B 27/01

(52) U.S. Cl. CPC G02B 27/0172; G02B 2027/0187

(57) ABSTRACT

An eye tracking system includes, in addition an eye tracking camera, one or more illuminator assemblies. The illuminator assemblies include a light source (e.g., a light emitting diode (LED), a laser source, etc.) and provide infrared or near-infrared (NIR) light. The radiated light from the light source is received at and provided as a beam shaped light by a beam shaping element onto an eye box. A direction and/or a spread of beam shaped light is controlled by the beam shaping element. A collimator may be used between the light source and the beam shaping element to collimate the radiated light onto the beam shaping element for increase efficiency. The beam shaping element may be a diffractive optical element (DOE), with an angle and shape of diffractors selected based on a designated direction and spread of beam shaped light.

### CROSS REFERENCE TO RELATED APPLICATIONS

This patent application claims priority to U.S. Provisional Patent Application No. 63/401,317, entitled “SYSTEM AND METHOD USING EYE TRACKING ILLUMINATION,” filed on Aug. 26, 2022.

### TECHNICAL FIELD

This patent application relates generally to eye tracking in near-eye display devices, and more specifically, to a system and method using an eye tracking system to bypass a corrective optical element and using beam shaping to focus illumination onto an eye box.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIGS. 3A and 3B illustrate a perspective view and a top view of a near-eye display in the form of a pair of glasses, according to an example.

FIG. 4A illustrates a perspective view of a near-eye display with light sources for an eye tracking system, according to an example.

FIG. 4B illustrates a side view of the near-eye display of FIG. 4A with illumination from the light sources.

FIG. 4C illustrates an illumination pattern of the light sources in the near-eye display of FIG. 4A.

FIG. 5A illustrates a side view of a near-eye display with an eye tracking illuminator assembly bypassing a corrective lens, according to an example.

FIGS. 5B and 5C illustrate a side view and a perspective view of components of the eye tracking illuminator assembly of FIG. 5A, according to an example.

FIG. 5D illustrates a side view of a specific implementation of the components of the eye tracking illuminator assembly of FIG. 5A, according to an example.

FIG. 6A illustrates an illumination pattern of a radiated beam in the eye tracking illuminator assembly of FIG. 5A, according to an example.

FIG. 6B illustrates an illumination pattern of a shaped beam in the eye tracking illuminator assembly of FIG. 5A, according to an example.

FIGS. 7A and 7B illustrate various implementations of an eye tracking illuminator assembly, according to examples.

FIG. 8 illustrates a flow diagram for a method of providing beam shaped illumination light for an eye tracking system in a near-eye display, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Tracking a position and orientation of the eye as well as gaze direction in head-mounted display (HMD) devices may unlock display and rendering architectures that can substantially alleviate the power and computational requirements to render 3D environments. Furthermore, eye-tracking enabled gaze prediction and intent inference can enable intuitive and immersive user experiences adaptive to the user requirements in his/her interaction with the virtual environment.

Some eye tracking implementations may include one or more illuminators along a periphery of a near-eye display to illuminate an eye box and/or to provide glint illumination, which may be used in various eye tracking techniques. Embedding illuminators along the periphery of the near-eye display may present design and manufacturing challenges, for example, positioning the illuminators to aim their illumination patterns to the eye box. Furthermore, in cases where a corrective lens (i.e., prescription lens) or similar optical element is used in conjunction with the near-eye display, the corrective lens or similar optical element may distort the illumination patterns of the illuminators degrading their performance.

In some examples of the present disclosure, an eye tracking system may include, in addition an eye tracking camera, one or more illuminator assemblies. The illuminator assemblies may include a light source (e.g., a light emitting diode (LED), a laser source, etc.) and provide infrared or near-infrared (NIR) light. The radiated light from the light source may be received at and provided as a beam shaped light by a beam shaping element onto an eye box. A direction and/or a spread of the beam shaped light may be controlled by the beam shaping element. In some examples, a collimator (e.g., an optical lens, a lens array, a phase plate, or a pinhole collimator) may be used between the light source and the beam shaping element to collimate the radiated light onto the beam shaping element for increase efficiency.

In some examples, the beam shaping element may include a diffractive optical element (DOE), for example a number of prisms on a base substrate, where an angle and shape of each prism may be selected based on a designated direction and spread of the beam shaped light. The illuminator assemblies may also include lightguides mechanically coupled between the light sources and the beam shaping elements, which may provide, in addition to transferring the radiated light, mechanical support between the display frame and the ring. The ring may enclose a corrective optical lens, a polarizer, a filter, a phase plate, or comparable optical elements.

While some advantages and benefits of the present disclosure are apparent, other advantages and benefits may include increased eye box illumination, which in turn may result in increased speed of eye tracking without added complexity to the eye tracking system. As narrower illumination patterns may be directed to the eye box, less power may be needed for the illuminators lowering an overall power consumption of the near-eye display.

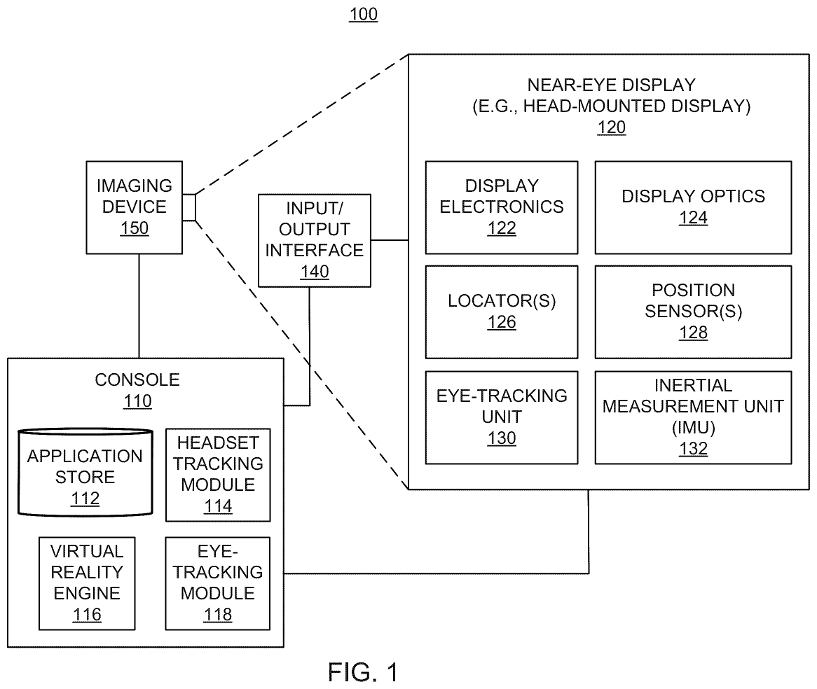

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

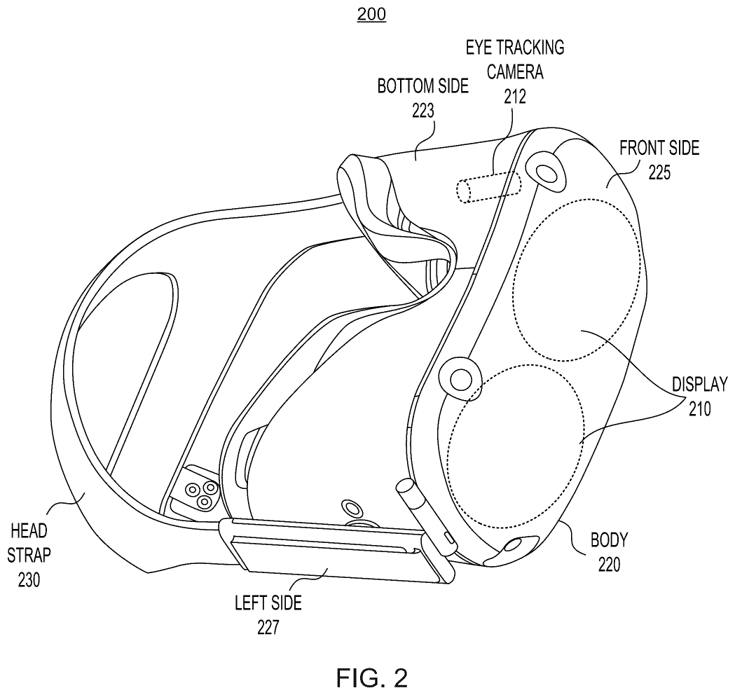

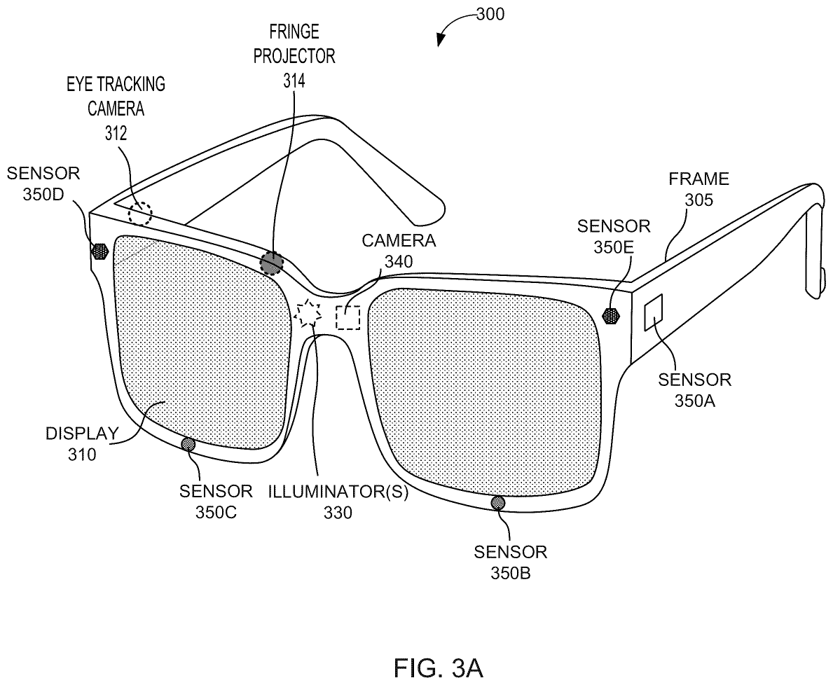

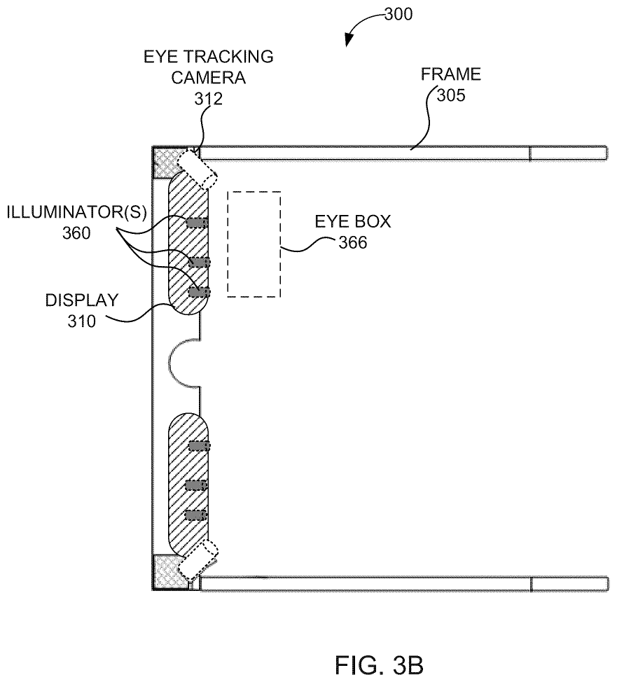

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern or glint illumination) that is directed to an eye such that light reflected by the eye may be captured by the imaging system (e.g., a camera). In other examples, the eye tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head-mounted device (HMD) device 200 may be a part of a virtual reality (VR) system, an augmented reality (AR) system, a mixed reality (MR) system, another system that uses displays or wearables, or any combination thereof. In some examples, the head-mounted display (HMD) device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components.

In some examples, the head-mounted display (HMD) device 200 may present, to a user, media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface 140 for communicating with a console 110, as described with respect to FIG. 1. In some examples, the head-mounted display (HMD) device 200 may include a virtual reality engine (not shown), but similar to the virtual reality engine 116 described with respect to FIG. 1, that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine 116 may be used for producing a signal (e.g., display instructions) to the one or more display assemblies. In some examples, the head-mounted display (HMD) device 200 may include locators (not shown), but similar to the virtual locators 126 described in FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, the projector may provide a structured light (fringe pattern) onto the eye which may be captured by the eye tracking camera 212. The eye tracking camera 212 or a communicatively coupled processor (e.g., eye tracking module 118 in FIG. 1) may analyze the captured reflection of the fringe pattern and analyze to generate a phase map of the fringe pattern, which may provide depth information for the eye and its structures.

FIG. 3A is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include temples 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display 300 may include a projector.

In some examples, the near-eye display 300 may further include various sensors 350a, 350b, 350c, 350d, and 350e on or within the temples 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display 300 may also include an eye tracking camera 312.

FIG. 3B is a top view of a near-eye display 300 in the form of a pair of glasses (or other similar eyewear), according to an example. In some examples, the near-eye display 300 may include a form factor of a pair of eyeglasses. The eyeglasses may support, for each eye: a display 310 to present content to an eye box 366, an eye tracking camera 312, and one or more illuminators 360. The illuminators 360 may be used for illuminating an eye box 366, as well as, for providing glint illumination to the eye. The display 310 may include a pupil-replicating waveguide to receive the fan of light beams and provide multiple laterally offset parallel copies of each beam of the fan of light beams, thereby extending a projected image over the eye box 366.

The eye tracking camera 312 may be used to determine position and/or orientation of both eyes of the user. Once the position and orientation of the user's eyes are known, a gaze convergence distance and direction may be determined. The imagery displayed by the display 310 may be adjusted dynamically to account for the user's gaze, for a better fidelity of immersion of the user into the displayed augmented reality scenery, and/or to provide specific functions of interaction with the augmented reality. In operation, the illuminators 360 may illuminate the eyes at the corresponding eye boxes 366, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 366.

In some examples, the image processing and eye position/orientation determination functions may be performed by a central controller, not shown, of the near-eye display 300. The central controller may also provide control signals to the display 310 to generate the images to be displayed to the user, depending on the determined eye positions, eye orientations, gaze directions, eyes vergence, etc.

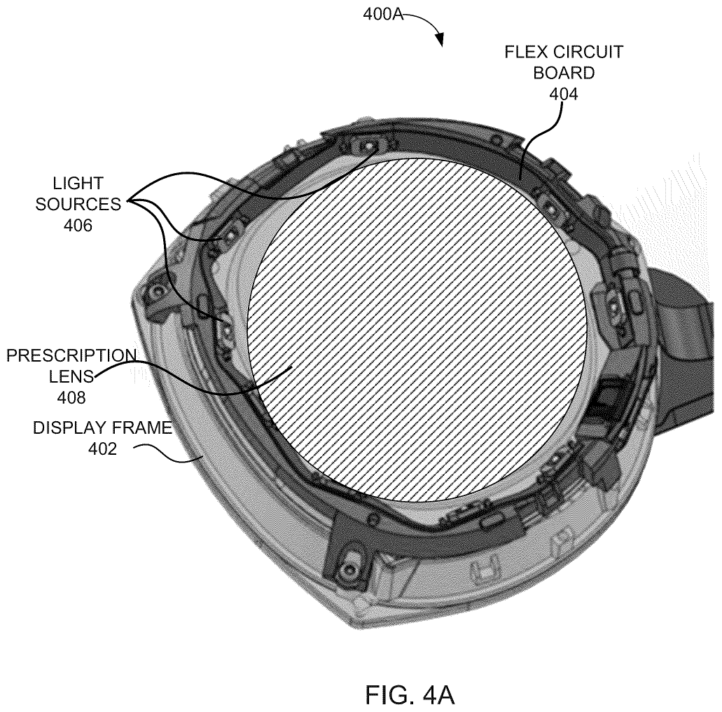

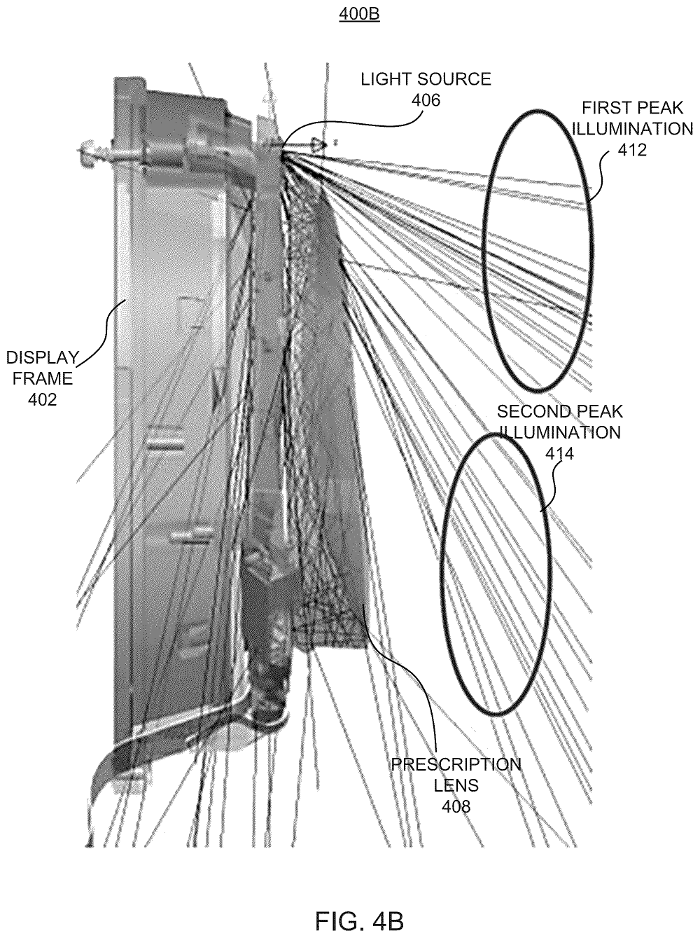

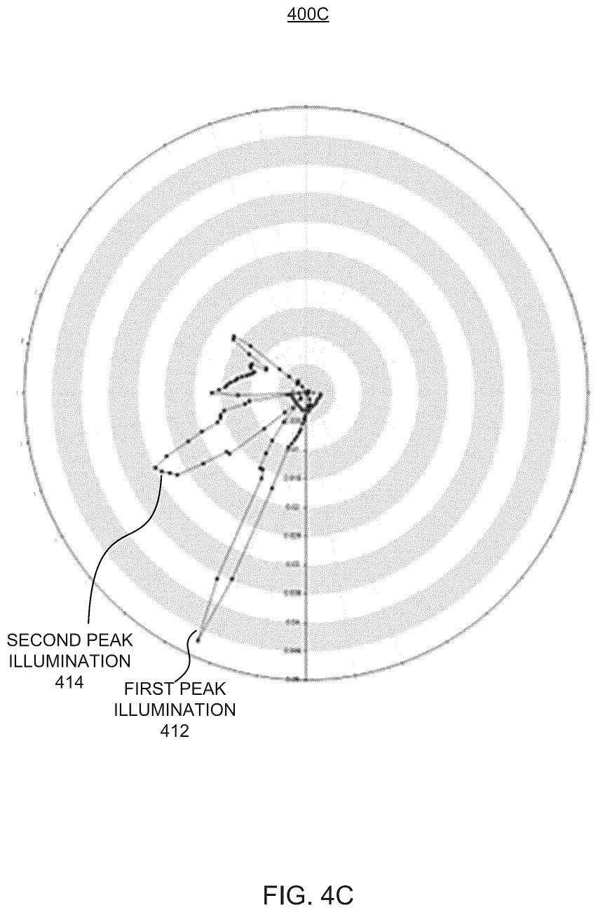

FIG. 4A illustrates a perspective view of a near-eye display with light sources for an eye tracking system, according to an example. Diagram 400A shows a frame 402 of a display of a near-eye display device with light sources 406 for eye tracking illumination, and a flexible circuit board 404 housing the light sources 406. A corrective optical element (prescription lens 408) that may be used in conjunction with the near-eye display is also shown in the diagram.

Eye tracking obtains data about a user's eye(s) such as detecting presence, attention, focus, a position of a person's pupil, and pupil size. Data points such as pupil position, gaze vector of the eye, gaze point, and eye openness may be computed from the captured eye tracking information. With the gathered data, images may be projected into the user's eye more accurately and user's intent may be detected (as input to an interactive display system, for example.

Some eye tracking systems may employ structured light projection onto the eye and use fringe analysis to track the eye. Some structured light based eye tracking systems may be supplemented with glint analysis using one or more illuminators to emit light onto an eye surface in order to generate glint(s). Yet, other eye tracking systems may utilize infrared or near-infrared (NIR) light from one or more illuminators to obtain depth information and track the eye. Combinations of various eye tracking systems may also be implemented.

Accordingly, illuminators directed toward the eye may be needed in a majority of eye tracking systems. In the near-eye display of diagram 400A display components such as a transmissive display, a quarter wave plate (QWP), various optical lenses, and/or transparent electronics layers may be enclosed by the display frame 402. To direct illumination from the light sources 406 (illuminators), the light sources 406 may be positioned on a flexible circuit board 404, which may be placed along an eye-facing periphery of the display frame 402. To ensure proper direction of the illumination toward the eye, the eye-facing surface of the display frame 402 may be formed at a predefined angle or additional material such as foam may be used to adjust a normal angle of the illuminators and/or to block light toward certain angles.

Standard near-eye displays may need additional components for users without ideal vision. Thus, a corrective lens (prescription lens 408) may be placed in front of the display, for example, in a ring that is mechanically attached to the display frame 402. One or both of the additional material to adjust illuminator angle (foam) and the corrective lens may, however, degrade an illumination performance of the light sources 406. Not only may the light be absorbed by some of the additional components, but it may also be diffracted and scattered resulting in substantial loss of illumination efficiency for eye tracking.

FIG. 4B illustrates a side view of the near-eye display of FIG. 4A with illumination from the light sources. Diagram 400B shows a light source 406 (of a multitude of light sources) positioned along a periphery of a display frame 402 (on an eye-facing surface). As discussed above, the light source 406 (and the other light sources) may be on a flexible circuit board to direct its illumination toward the eye box. To secure and adjust the position of the light sources, foam or similar material may be used. However, such material may affect an illumination pattern of the light source 406. Furthermore, corrective optical elements such as prescription lens 408 may be used with an enclosing ring in front of the display frame 402, which may further affect the light source's illumination pattern resulting in distributed peak illuminations. For example, a first peak illumination 412 and a second peak illumination 414 may be generated. Multiple peak illuminations may mean significant loss of light reaching the eye box and reducing an efficiency of the eye tracking system. In addition, multi peak of beams may lead to duplicated glints on the pupil, which may cause degradation of tracking accuracy.

FIG. 4C illustrates an illumination pattern of the light sources in the near-eye display of FIG. 4A. Diagram 4000 shows how an illumination pattern of a light source on a display frame may be spread with multiple peaks such as the first peak illumination 412 and the second peak illumination 414. The multiple peaks may not only reduce total light reaching the eye for eye tracking purposes, but also change its direction. Thus, an accuracy of eye tracking may be severely degraded.

In addition to the illumination degradation shown in diagram 4000, an eye tracking system configuration shown in FIGS. 4A and 4B may also be subject to inaccurate aiming angle of the light sources (e.g., light emitting diodes (LEDs)), increased cost and complexity of the flexible circuit board and assembly of the system. To achieve reasonable eye tracking performance, the light sources in such a system may need to be higher power sources meaning higher electrical power consumption in a near-eye display device, where power availability is a challenge.

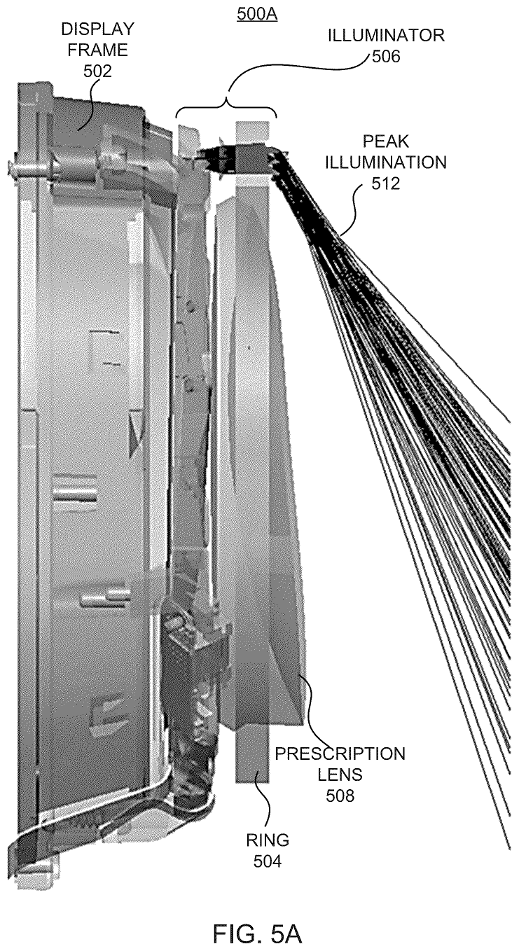

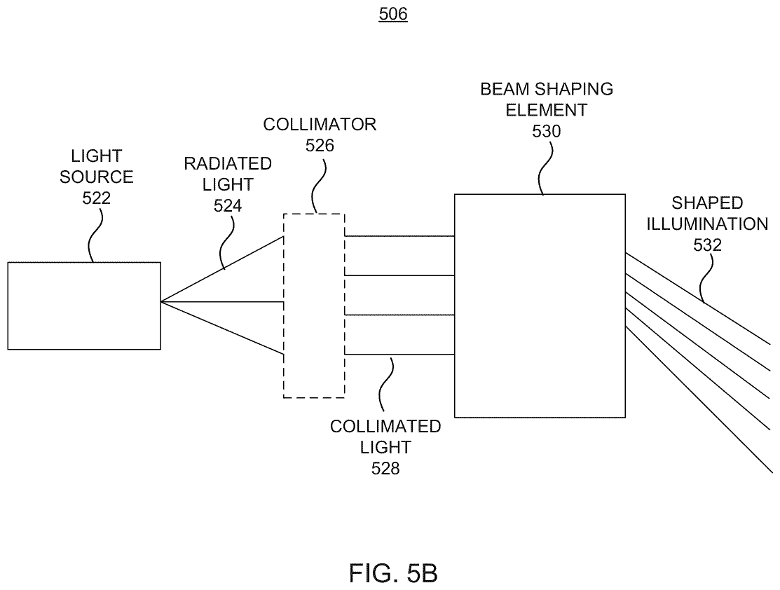

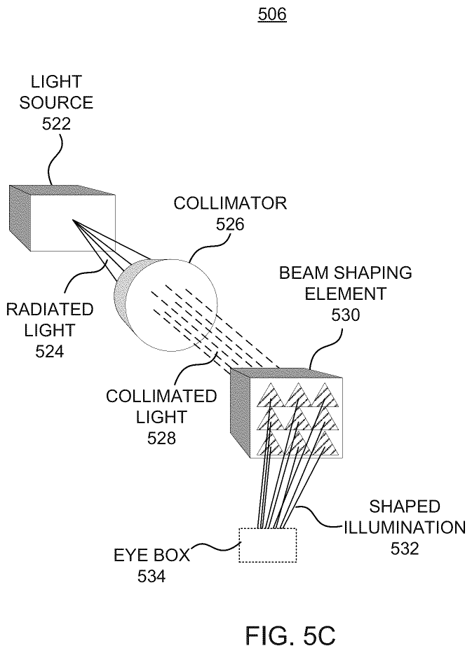

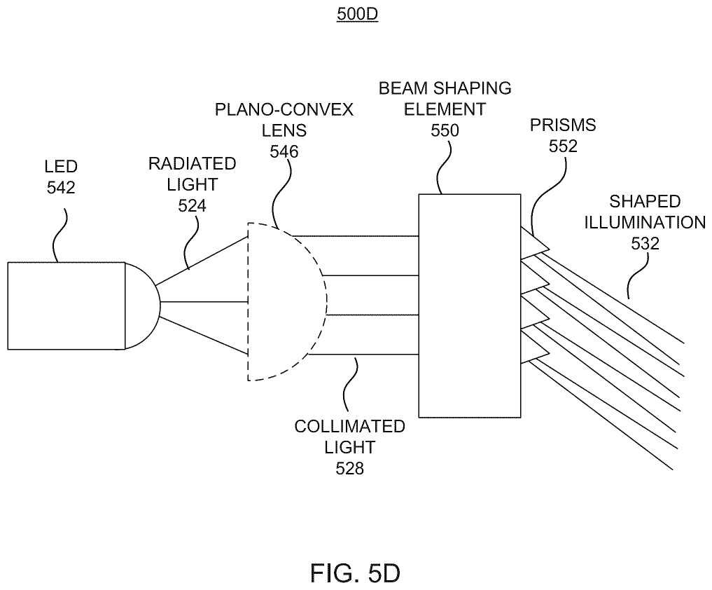

FIG. 5A illustrates a side view of a near-eye display with an eye tracking illuminator assembly bypassing a corrective lens, according to an example. Diagram 500A shows a display frame 502 enclosing display elements such as a transmissive display layer, a polarizer, a filter, an electronics layer, or similar components. A ring 504, mechanically coupled to and positioned in front of the display frame 502, may enclose corrective optical elements such as a prescription lens 508 or other components such as a polarizer, a filter, a quarter wave plate (QWP), and similar ones. An illuminator assembly 506 may be an assembly of components such as a light source positioned along the periphery of the display frame 502, a beam shaping element along the periphery of the ring 504, and an optional collimator between the light source and the beam shaping element. Through the use of the illuminator assembly a shaped light beam may be directed to an eye box with high efficiency such that peak illumination 512 is directed accurately at the eye box without interaction and degradation caused by the prescription lens 508 or any other components.

In some examples, the light source may be positioned with its emission direction normal to a surface of the display frame eliminating a need to set or adjust an angle of the light source accurately. Similarly, the beam shaping element may be positioned on the ring without a need for positioning angle. The direction of the peak illumination 512 may be determined by the design of the beam shaping element. Through the use of a collimator or a lightguide, light from the light source may be emitted toward the eye box with high efficiency. The components of the illuminator assembly may be injection molded or similarly formed on the display frame 502 and the ring 504. Thus, cost and complexity of adjustment components such as foam may be avoided. Furthermore, an interaction with the optical elements within the ring 504 (e.g., prescription lens 508) may be avoided. By achieving high efficiency and accurate direction control in illuminating the eye, lower power consuming light sources may be used reducing an overall power consumption of the near-eye display device.

FIGS. 5A and 5B illustrate a side view and a perspective view of components of the eye tracking illuminator assembly 506 of FIG. 5A, according to an example. The illuminator assembly 506, as described herein, may include a light source 522, which may provide radiated light 524 to an optional collimator 526, from which collimated light 528 may be provided to a beam shaping element 530. The beam shaping element 530 may provide direction and spread controlled shaped illumination 532 to an eye box 534.

In some examples, the light source 522 may include a side-emitting laser diode, a vertical-cavity surface-emitting laser diode, a superluminescent light-emitting diode, a light-emitting diode (LED), or similar sources. The light source 522 may emit infrared or near-infrared (NIR) light. The optional collimator 526 may be an optical lens, a phase plate, a lens array, a pinhole collimator, or similar components. The beam shaping element may be a diffractive optical element (DOE) and shape a direction and/or a spread o of the shaped illumination 532. Other beam shaping elements that can redirect beam may include, but are not limited to, a reflector, a refractor, a prism.

Accordingly, the beam shaping element 530 may ensure a narrow and accurately directed beam is provided to the eye. A narrow radiate light 524 from the light source 522 and/or the collimator 526 may further increase an efficiency of the system reducing loss of light between the light source 522 and the beam shaping element 530. Furthermore, the components of the illuminator assembly may be formed with ease on the display frame and/or the ring, for example, by injection molding eliminating the need for complex additional components such as a flexible circuit board.

FIG. 5C illustrates a side view of a specific implementation of the components of the eye tracking illuminator assembly of FIG. 5A, according to an example. Diagram 5000 shows a light emitting diode (LED) 542 used as light source providing the radiated light 524 to an option collimator, plano-convex lens 546. The collimated light 528 may be received by a beam shaping element 550 that includes a base substrate and multiple prisms 552. The prisms may be shaped and angled to provide the shaped illumination 532 to the eye. A minimum number of prisms may be one. A maximum number of prisms may be determined based on a surface area of the beam shaping element 550. For example, if the surface are of the beam shaping element 550 is x (mm)×y (mm), a maximum number of prisms may be determined by 10⁶xy.

The light emitting diode (LED) 542 may include an integrated beam shaping element such as a dome to radiate a narrow beam of light, which may eliminate the need to the plano-convex lens 546. Alternatively, the narrow beam from the light emitting diode (LED) 542 may be further collimated by the plano-convex lens 546 reducing loss of light between the light emitting diode (LED) 542 and the beam shaping element 550.

In some examples, angles of the prisms 552 may control outer beam directions of the shaped illumination 532. Shapes of the prisms 552 may control a beam spread. If larger coverage by the shaped illumination 532 is needed, downward facing surfaces of the prisms 552 may be curved or other shapes may be used. In some implementations, the light emitting diode (LED) 542 may have an emitting surface in a range between 0.2 and 0.3 millimeters. A number of light emitting diodes (LEDs) that may be distributed along a periphery of a display frame may depend on available space and overlap of LED beams. In some practical implementations up to 10 or 15 light emitting diodes (LEDs) may be used. Due to their size, the LEDs may not interfere with a performance of the components within the display frame. Accordingly, the collimator and the beam shaping element may also be in similar size to the light emitting diodes (LEDs). The light emitting diodes (LEDs) may be evenly distributed along the periphery of the display frame or they may be at precomputed locations.

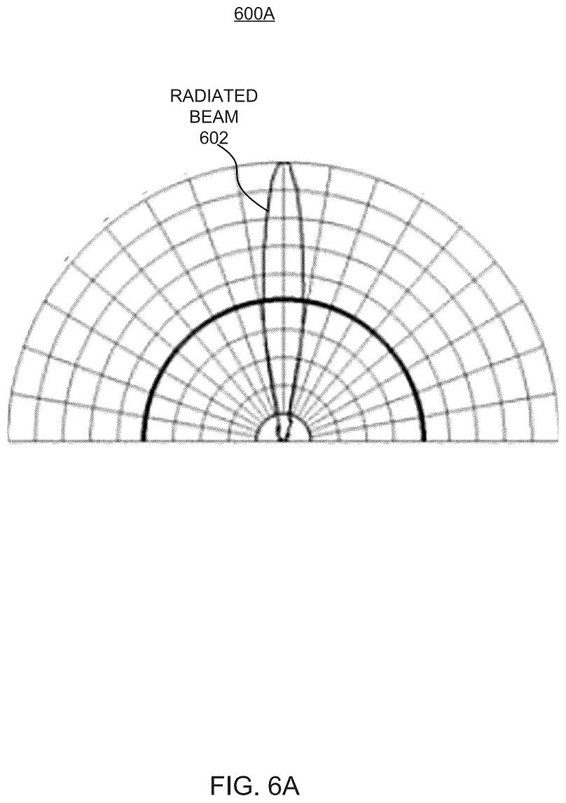

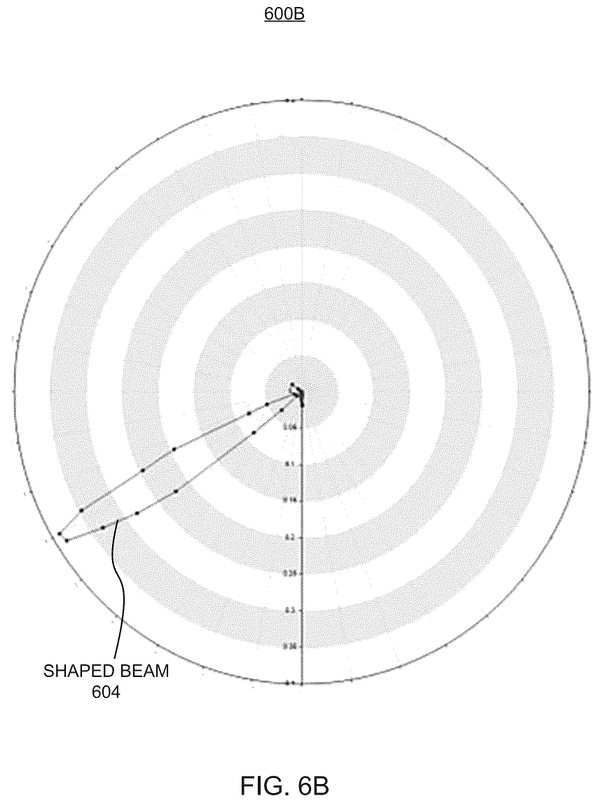

FIG. 6A illustrates an illumination pattern of a radiated beam in the eye tracking illuminator assembly of FIG. 5A, according to an example. Diagram 600A shows radiated beam 602 of a light source such as a light emitting diode (LED). The example radiated beam has a width of about 20 degrees. In some examples, a light emitting diode (LED) may be fitted with a beam shaping element such as a dome on its emitting surface to narrow its radiated beam. In other examples, inherently narrow output light sources such as a laser diode may be used. The narrow radiated beam 602 may ensure a large portion of the light from the light source to be received by the beam shaping element 530 of FIG. 5B for example. In other examples, a collimator such as a plano-convex lens may be used to collimate the radiated beam 602 onto a receiving surface of the beam shaping element.

FIG. 6B illustrates an illumination pattern of a shaped beam in the eye tracking illuminator assembly of FIG. 5A, according to an example. Diagram 600B shows shaped beam 604 from a beam shaping element such as the beam shaping element 530 of FIG. 5B. As shown in the diagram, not only is the beam directed to the eye box narrow (e.g., less than 20 degrees), but it is also directed accurately toward the eye box through the use of the beam shaping element. Furthermore, by using a narrow beam light source output and, optionally, a collimator, loss of light from the light source to the eye box may be minimized. Accordingly, less electrical power may be needed for the light source, which is an important aspect of near-eye display design. An intensity of the illumination on the eye box may also be increased allowing more accurate eye tracking.

The light beams discussed in FIGS. 6A and 6B are for illustration purposes. Example implementations may employ narrower or wider beams depending on types and shapes of the components used in the eye tracking illuminator assemblies.

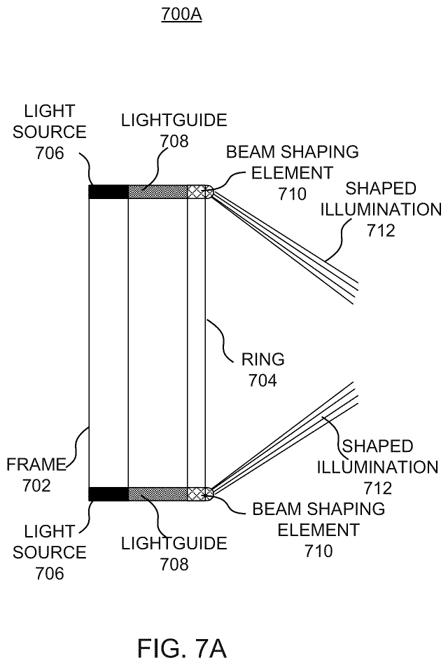

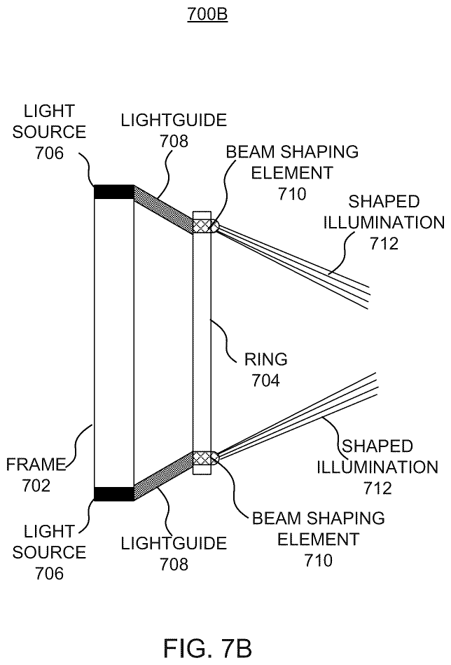

FIGS. 7A and 7B illustrate various implementations of an eye tracking illuminator assembly, according to examples. Diagram 700A in FIG. 7A shows a display frame 702 with two light sources 706. Lightguides 708 optically couple the light sources 706 to respective beam shaping elements 710, which provide shaped illumination 712 toward an eye box (not shown). In addition to providing optical coupling between the light sources 706 and the beam shaping elements 710, the lightguides 708 may also be used to mechanically couple and support the display frame 702 and the ring 704.

In some examples, the lightguides 708 may cover an emitting surface of respective light sources 702. Thus, radiated light beam may be provided to the beam shaping elements 710 with minimal loss. The lightguides 708 may be made from plastic or glass and have a refraction index suitable for relaying infrared or near-infrared (NIR) light. Light is transmitted through the lightguide via total internal reflection (TIR).

Diagram 700B in FIG. 7B shows the display frame 702 with the light sources 706. The lightguides 708 optically couple the light sources 706 to respective beam shaping elements 710, which provide shaped illumination 712 toward an eye box (not shown). As in the configuration of diagram 700A, the lightguides 708 may also be used to mechanically couple and support the display frame 702 and the ring 704.

The configuration in diagram 700B shows the lightguides 708 being at an off-normal angle to a surface plane of the display frame 702. For example, the ring 704 may have a smaller diameter compared to the display frame 702. Accordingly, the lightguides may be angled toward the smaller ring. In other examples, the lightguides may be angled in other directions, for example, toward a larger ring, etc. The angle of the lightguides may also be determined based on locations of the light sources and the beam shaping elements respectively on the display frame and the ring.

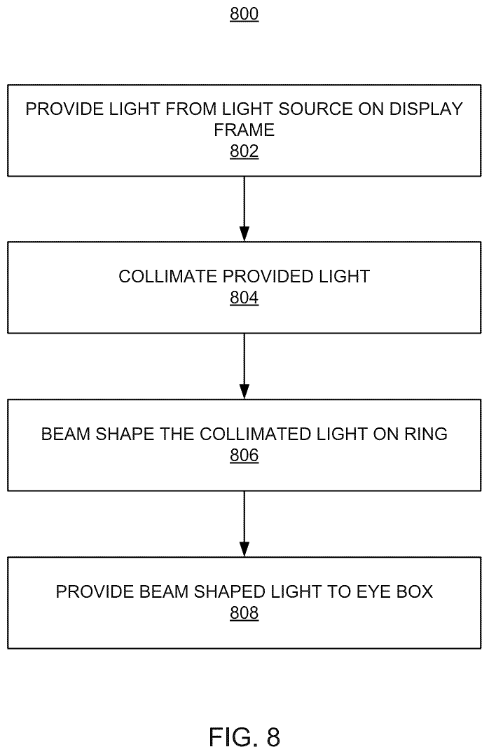

FIG. 8 illustrates a flow diagram for a method of providing beam shaped illumination light for an eye tracking system in a near-eye display, according to some examples. The method 800 is provided by way of example, as there may be a variety of ways to carry out the method described herein. Although the method 800 is primarily described as being performed by the components of FIGS. 5B and 5C, the method 800 may be executed or otherwise performed by one or more processing components of another system or a combination of systems. Each block shown in FIG. 8 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 802, a light source such as a light-emitting diode (LED), or a side-emitting laser diode, a vertical-cavity surface-emitting laser diode, or a superluminescent light-emitting diode, may radiate a light beam (e.g., infrared or near-infrared (NIR) light). The light source may be one of a multitude of light sources distributed along a periphery of a display frame of a near-eye display device.

At block 804, the radiated light from the light source may be collimated toward a beam shaping element. In some examples, the light source may be configured to provide a narrow shaped light beam (e.g., through an integrated beam shaping element). In other examples, an optical element such as an optical lens, a lens array, a phase plate, or a pinhole collimator may be used to collimate the radiated light from the light source.

At block 806, the collimated light beam received at the beam shaping element may be shaped with a controlled beam spread and direction. The beam shaping element may be diffractive optical element (DOE). For example, the beam shaping element may include a multitude of prisms on a base substrate, where an angle of each prism may determine a direction of the beam shaped light. A shape of each prism may determine a spread of the beam shaped light. At block 808, the shaped beam may be provided to an eye box by the beam shaping element.

According to examples, a method of making an eye tracking system with beam shaped illumination is described herein. A system of making the eye tracking system with beam shaped illumination is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An illuminator assembly, comprising:
a light source positioned along a periphery of a display frame to radiate light;
a beam shaping element positioned on a ring mechanically coupled to the display frame, the beam shaping element to:
receive the radiated light from the light source; and
provide beam shaped light onto an eye box bypassing one or more optical elements enclosed by the ring.

2. The illuminator assembly of claim 1, further comprising:
a collimator positioned between the light source and the beam shaping element, the collimator to receive the radiated light and to provide collimated light to the beam shaping element.

3. The illuminator assembly of claim 2, wherein the collimator comprises an optical lens, a phase plate, a lens array, or a pinhole collimator.

4. The illuminator assembly of claim 1, wherein the light source comprises a side-emitting laser diode, a vertical-cavity surface-emitting laser diode, or a light-emitting diode (LED).

5. The illuminator assembly of claim 1, wherein the light source radiates one or more of infrared light or near-infrared (NIR) light.

6. The illuminator assembly of claim 1, wherein the beam shaping element is a diffractive optical element (DOE) arranged to shape one or more of a direction of the beam shaped light and a spread of the beam shaped light.

7. The illuminator assembly of claim 1, wherein:
the beam shaping element comprises:
a plurality of angled prisms positioned on a base substrate, wherein:
an angle of each prism determines a direction of the beam shaped light, and
a shape of each prism determines a spread of the beam shaped light.

8. The illuminator assembly of claim 7, wherein a number of the angled prisms is in a range between 4 and 10.

9. The illuminator assembly of claim 1, further comprising a lightguide coupled between the light source and the beam shaping element, wherein the lightguide is to:
provide the radiated light to the beam shaping element, and
provide mechanical support between the display frame and the ring.

10. The illuminator assembly of claim 1, wherein the one or more optical elements enclosed by the ring comprise a corrective optical lens, a polarizer, a filter, or a phase plate.

11. An eye tracking system for a head-mounted display (HMD), comprising:
an eye tracking camera; and
one or more illuminator assemblies, wherein each illuminator assembly comprises:
a light source positioned along a periphery of a display frame to radiate light;
a beam shaping element positioned on a ring mechanically coupled to the display frame, the beam shaping element to:
receive the radiated light from the light source; and
provide beam shaped light onto an eye box bypassing one or more optical elements enclosed by the ring.

12. The eye tracking system of claim 11, wherein each illuminator assembly further comprises:
a collimator comprising an optical lens, a phase plate, a lens array, or a pinhole collimator positioned between the light source and the beam shaping element, wherein the collimator is to receive the radiated light and to provide collimated light to the beam shaping element.

13. The eye tracking system of claim 11, wherein the light source radiates one or more of infrared light or near-infrared (NIR) light and comprises a side-emitting laser diode, a vertical-cavity surface-emitting laser diode, or a light-emitting diode (LED).

14. The eye tracking system of claim 11, wherein the beam shaping element is a diffractive optical element (DOE) arranged to shape one or more of a direction of the beam shaped light and a spread of the beam shaped light.

15. The eye tracking system of claim 11, wherein the one or more illuminator assemblies comprise a plurality of illuminator assemblies evenly distributed along the periphery of the display frame.

16. The eye tracking system of claim 11, wherein:
the beam shaping element comprises:
a plurality of angled prisms positioned on a base substrate, wherein:
an angle of each prism determines a direction of the beam shaped light, and
a shape of each prism determines a spread of the beam shaped light.

17. The eye tracking system of claim 11, wherein each illuminator assembly further comprises a lightguide coupled between the light source and the beam shaping element, wherein the lightguide is to:
provide the radiated light to the beam shaping element, and
provide mechanical support between the display frame and the ring.

18. A method, comprising:
emitting infrared light or near-infrared (NIR) light from a light source positioned along a periphery of a display frame;
collimating the emitted light onto a beam shaping element positioned on a ring mechanically coupled to the display frame; and
emitting beam shaped light from the beam shaping element onto an eye box bypassing one or more optical elements enclosed by the ring.

19. The method of claim 18, wherein emitting the beam shaped light onto the eye box comprises:
controlling one or more of a direction of the beam shaped light and a spread of the beam shaped light.

20. The method of claim 19, wherein
the beam shaping element comprises a plurality of angled prisms positioned on a base substrate,
controlling the direction of the beam shaped light comprises selecting an angle of each prism, and
controlling the spread of the beam shaped light comprises selecting a shape of each prism.
